(19) United States
(12) Patent Application Publication
(10) Pub. No.: US 2014/0282178 A1
(43) Pub. Date: Sep. 18, 2014

(54) PERSONALIZED COMMUNITY MODEL FOR SURFACING COMMANDS WITHIN PRODUCTIVITY APPLICATION USER INTERFACES

(71) Applicant: MICROSOFT CORPORATION, Redmond, WA (US)

(72) Inventors: Eric M. Borzello, Redmond, WA (US); Richard Anthony Caruana, Woodinville, WA (US); Eric Joel Horvitz, Kirkland, WA (US); Ashish Kapoor, Kirkland, WA (US); Kathleen R. Kelly, Bellevue, WA (US); Charles Marcus Reid, III, Kirkland, WA (US)

(73) Assignee: MICROSOFT CORPORATION, Redmond, WA (US)

(21) Appl. No.: 13/831,886

(22) Filed: Mar. 15, 2013

(51) Int. Cl. G06F 3/0484

(52) U.S. Cl. CPC G06F 3/0484
USPC 715/771

(57) ABSTRACT

Systems and techniques for facilitating and backing the surfacing of predicted commands within a user interface are disclosed. Commands to surface for an active user in productivity applications can be predicted using a personalized community model. The personalized community model is generated using a record of past actions the active user has taken along with the past actions of many users of the productivity application. The actions of the active user within the productivity application are monitored and used to select commands to surface.

### BACKGROUND

Productivity applications provide significant capabilities at a person's fingertips to create and modify content. As these programs expand to include more features and functions, the number of available commands that a user can perform increases. Even some of the most knowledgeable users may take advantage of only a fraction of the available commands. User interfaces for productivity applications generally include menus and toolbars that allow a user to access features and functions of the application in order to execute the commands. However, finding a feature a user needs to perform a certain task can be a challenge—and users may not realize certain commands exist. It is not uncommon for a user to spend time searching for a command in various menus, which decreases productivity and increases frustration.

### BRIEF SUMMARY

Techniques for facilitating and backing the surfacing of predicted commands to a displayed user interface are disclosed. According to certain embodiments, user models based on a personalized community model are used to support the predicting of commands.

Systems are also disclosed that can perform the described techniques such that a user interface of a productivity application can surface commands that a user may want to use as they need them. In order to facilitate the surfacing of predicted commands to a displayed user interface, a prediction engine is provided.

The prediction engine monitors current actions of an active user and selects one or more most likely commands that the user may want next. The prediction engine may generate a personalized community model by incorporating aggregate user data along with the active user's history and/or context. Then, based on the active user's current actions (or inaction), the prediction engine selects probable next actions. A confidence threshold can be provided to facilitate which commands are displayed. In one embodiment, the confidence can be a sum of multiple commands' confidence values.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an example operating environment in which various embodiments of the invention may be practiced.

FIG. 2 shows a diagram of a system for surfacing commands within a user interface according to an embodiment of the invention.

FIGS. 3A and 3B show example scenarios that may be implemented by embodiments of the invention.

FIG. 4 shows a process flow diagram of a method for surfacing commands within a user interface of a productivity application according to an embodiment of the invention

FIG. 5 shows a user interface in which predicted commands are surfaced according to an embodiment of the invention.

FIG. 6 shows an example process by which predicted commands are surfaced in a user interface according to an embodiment of the invention

FIG. 7 shows an illustrative architecture for a user device on which embodiments of the invention may be implemented.

FIG. 8 shows a block diagram illustrating components of a computing device used in some embodiments.

### DETAILED DESCRIPTION

Systems and techniques are described that back a user interface of a productivity application with a user model, incorporating a personalized community model, designed to surface the commands a user may want to use as they need them.

Productivity applications include authoring tools for creating and editing documents, presentations, spreadsheets, databases, charts and graphs, images, video, audio, and the like. These applications can be in the form of a word processing software, spreadsheet software, personal information management (PIM) and email communication software, presentation programs, note taking/storytelling software, diagram and flowcharting software, and the like. Examples of productivity applications include the MICROSOFT OFFICE suite of applications from Microsoft Corp., such as MICROSOFT WORD, MICROSOFT EXCEL, MICROSOFT ONENOTE, all registered trademarks of Microsoft Corp. Productivity applications may also include computer aided design (CAD) applications.

Within productivity applications, a command generally refers to a directive to perform a specific task related to a feature available in the productivity application, and is applied by a user clicking on an icon or character representing the particular feature or by performing some other action (via touch or voice) to select the command. Examples of commands within a productivity application include, but are not limited to, copy, paste, underline, cut, highlight, increase/decrease font size, fill, insert, and sort.

There may be a wide variety of commands in a user interface (UI) of a productivity application. In some cases thousands of commands may be available. Many of those commands have been designed to increase user productivity and help users accomplish various tasks; however, it can be a challenge to find certain commands and/or know when a command provided in the UI could be used for the user's benefit.

According to certain embodiments, a personalized user model built upon a community model is provided for dynamically surfacing commands within a productivity application.

FIG. 1 shows an example operating environment in which various embodiments of the invention may be practiced. Referring to FIG. 1, a user 105 may interact with a user computing device 110 running an application 112, such as a productivity application, through a UI 114 displayed on a display 116 associated with the computing device 110.

A computing device (e.g., the user computing device 110) is configured to receive input from a user (e.g., user 105) through, for example, a keyboard, mouse, trackpad, touch pad, touch screen, microphone, or other input device. The display 116 of the user computing device 110 is configured to display one or more user interfaces (including UI 114) to the user 105. In some embodiments, the display 116 can include a touchscreen such that the user computing device 110 may receive user input through the display.

The UI 114 enables a user to interact with various applications, such as a productivity application, running on or displayed through the user computing device 110. For example, UI 114 may include the use of a context menu, a menu within a menu bar, a menu item selected from a ribbon user interface, a graphical menu, and the like. Menus may be in a traditional bar form or in a ribbon form or as a palette or other presentation of commands. Generally, UI 114 is configured such that a user may easily interact with functionality of an application. For example, a user may simply select (via, for example, touch, clicking, gesture or voice) an option within UI 114 to perform an operation such as formatting content being authored or edited in an application 112.

The user 105 can execute numerous commands through the UI 114 in order to perform specific tasks related to features available in the application 112. In some cases, the user 105 may have multiple devices running a similar program and the user 105 can edit a same or different document (or other content) across multiple user computing devices (such as second device 118-1 and/or third device 118-2).

The user computing device 110 (as well as the second device 118-1 and the third device 118-2) may operate on or in communication with a network 120, and may communicate with one or more servers 130 over the network 120.

The network 120 can be, but is not limited to, a cellular network (e.g., wireless phone), a point-to-point dial up connection, a satellite network, the Internet, a local area network (LAN), a wide area network (WAN), a WiFi network, an ad hoc network or a combination thereof. Such networks are widely used to connect various types of network elements, such as hubs, bridges, routers, switches, servers, and gateways. The network 120 may include one or more connected networks (e.g., a multi-network environment) including public networks, such as the Internet, and/or private networks such as a secure enterprise private network. Access to the network 120 may be provided via one or more wired or wireless access networks as will be understood by those skilled in the art.

As will also be appreciated by those skilled in the art, communication networks can take several different forms and can use several different communication protocols. Certain embodiments of the invention can be practiced in distributed-computing environments where tasks are performed by remote-processing devices that are linked through a communications network. In a distributed-computing environment, program modules can be located in both local and remote computer-readable storage media.

The user computing device 110 can be, but is not limited to, a personal computer (e.g. desktop computer), laptop, personal digital assistant (PDA), video game device, mobile phone (or smart phone), tablet, slate, terminal, and the like. It should be apparent that the user computing device 110 may be any type of computer system that provides its user the ability to load and execute software programs and the ability to access a network, such as network 120. The second device 118-1 and third device 118-2 may include the same types of devices (or systems) as user computing device 110 and they may or may not be of a same form. For example, a user 105 may have a laptop, a tablet, and a smart phone as the three devices.

The application 112 can be stored on the user computing device 110 (e.g., a client-side application). In another embodiment, the user 105 may access a web-based application 132 (e.g., running on server 130 or hosted on a cloud) using a web browser (e.g., a standard internet browser), and the application's interface may be displayed to the user 105 within the web browser. Thus, the application may be a client-side application and/or a non-client side (e.g., a web-based) application.

According to certain embodiments of the invention, while the user is executing commands in the UI 114, a usage log can be stored for each session. For example, when a user executes commands within a productivity application, the command can be logged. The logging of the command can be performed locally at the user computing device 110 and/or at a database 140 associated with a server (such as server 130) or cloud service. Through the logging of commands, a record of past actions the user has taken while using the productivity application can be stored. Command usage may be stored specific for the user 105. For example, a command log may be created as a usage history for a specific user.

With the user's permission, the command usage may also be stored in a community log. The community log can contain an aggregate of information relating to command usage for a community of users. For example, usage information from users of other computing devices, such as second user computing device 150 and third user computing device 152, can be communicated over the network 120 and stored in the database 140. The community log may be managed by a server or service associated with the application.

According to various embodiments, information that can be stored, for example in a community log, by the system (either as part of a local storage/memory or database associated with a server or cloud service) includes, but is not limited to, configuration information including hardware, operating system (OS), and software of the user's computing device (e.g., user computing device 110); performance and reliability information including response times and connection speeds; and program use information, such as executed commands. Personal data—unless actively provided or authorized—is not collected for the community log and any data stored by the system for use by anyone other than the active user can be anonymous. An active user refers to the user to which the predicted commands are customized and displayed.

In one embodiment, a user specific command log may store the commands in the order that the commands were used. In many embodiments, the command log stores the time that a command was used. For example, a code and/or command name can be stored to represent the command that was used along with a timestamp indicative of when the command was used. The timestamp can be used to determine the amount of time since a command was executed as well as facilitate other temporal calculations used in surfacing a predictive command. In certain embodiments, a command log can store a tuple containing a user identifier (id), command id (or name), and timestamp. Other data may also be stored.

Table 1 shows a sample trace of ten ordered commands from a single user session (one user 1234567 during session 1111111111).

TABLE 1

| user id | session id | Sequence | command name |
|---|---|---|---|
| 1234567 | 1111111111 | 1 | Paste |
| 1234567 | 1111111111 | 2 | Format font |
| 1234567 | 1111111111 | 3 | Format font |
| 1234567 | 1111111111 | 4 | Format font |
| 1234567 | 1111111111 | 5 | Highlight |
| 1234567 | 1111111111 | 6 | Cut |
| 1234567 | 1111111111 | 7 | Paste |
| 1234567 | 1111111111 | 8 | Insert image |
| 1234567 | 1111111111 | 9 | Insert image |
| 1234567 | 1111111111 | 10 | Highlight |

A user specific command log or the community log may include the information provided in Table 1. In this example, a user may have performed the command Paste followed by three Format font commands, then a Highlight, Cut, Paste, two Insert image commands, and then another Highlight. This user history information can be used to predict a next command.

Including a user id allows for sorting, filtering, or selection of data (from the community log) based on user. As mentioned above, the actual identity of the user associated with the user id may be kept anonymous. Instead, traits or attributes about the user can be inferred from the logged commands or known from information about the user given, with permission, from the user.

Although a sequence is illustrated as being part of the table, the sequence may be assigned based on the order that the commands are stored or an associated timestamp (not shown) for the commands.

In a further embodiment, when permitted by a user, the command log may also store the location where the command was used. The location may be in the form of geo-coordinates, Cell ID, address, computer name, or the like.

The information in the command log associated with usage history of a specific user (e.g., the user specific command log) can be combined with information from the community log to generate a personalized community model, which is based on the past actions of many users of the productivity application over time. The personalized community model can employ specific user data from the command log and community data from the community log to predict a next action.

User experience can be tailored to a user's individual style through predictions based on personalized community models of embodiments of the invention. The predictions can be presented, for example, as part of a command and feature search or as part of a dynamic predictive toolbar. In order to facilitate the surfacing of predicted commands to a displayed UI, a prediction engine is provided. The prediction engine can access a user model for predicting the next action a user will take.

The user model includes information corresponding to usage patterns and can include the personalized community model. The user model is generated by processing data from the user specific command log and/or the community command log. The prediction engine is used to provide a suggestion for the next action for a user by surfacing a predicted command.

In many embodiments, the next action is a command. In some embodiments, the next action predicted by the system may be a command or may be some other action with respect to the program being used by the user or even some other program, product, or device. Other actions include, but are not limited to, sending or receiving an email, instant message, or voice or video call.

FIG. 2 shows a diagram of a system for surfacing commands within a user interface according to an embodiment of the invention.

Referring to FIG. 2, the system can include a prediction engine 200. The prediction engine 200 can be implemented using hardware and/or software. The prediction engine 200 can include prediction algorithms in the form of computer executable instructions stored on one or more computer-readable media and which can be carried out using a processor (e.g., a processor of user computing device 110). In some embodiments, the prediction algorithms can be in the form of logic performed in whole or in part by programmable logic gates or other hardware implementations.

The prediction engine 200 can receive data, determine probabilities, and output predictive commands based on the determined probabilities. The data used by the prediction engine 200 can include community data 210, user specific data 220, and context data 230. Commands predicted by the prediction engine 200 can be output on a display 240 of, for example, a user computing device as part of a UI of an application such as a productivity application.

Community data 210 can be obtained from a community log and can be stored in any suitable format that can convey relationships between the data, for example as a table, and that is searchable (e.g., can be parsed). A local copy of the community log may be available to a user computing device (and the prediction engine 200).

User specific data 220 can be obtained from a user specific log. The user specific log can be a command log of the user such that the user specific data 220 provides usage history of the active user.

In addition to user specific data 220 and the community data 210, the prediction engine 200 can receive context data 230 to generate predictions. Some context data may be obtained from the user specific data (received from a user specific command log). In other cases, the context data is obtained from other memory locations storing information related to a current productivity application session of an active user.

Context includes, but is not limited to, when a command occurred (date/time), length of time between interactions (or amount of time since last action or command), certain actions or inactions by a user, location (geo-location, home, office, mobile), content (in a document or file being interacted with within the productivity application), history (information in addition to rate of occurrence of next command), client type, application permissions (reader mode, full editing mode), application type, application state (selection of text or image, new document, existing document), file, and the like. Context can also include immediate preceding commands of the user.

The community data 210 from the community log and the user specific data 220 from the user specific log can be obtained according to a particular command log view. A “command log view” refers to the portions of the data in the log that are used as part of the data stream processed by the prediction engine. In some embodiments, the prediction engine may generate the command log view(s). A command log view can be based on, but not limited to, command frequency (e.g., occurrence rate or count of command usage), user/client categorization (e.g., type of client accessing the data), scenarios present in the log, or the time of day the command was executed. Context data 230 can be used to augment predictions and, in some embodiments, facilitate command log view selection from one or both data sources (e.g., from the user specific log and the community log).

Examples of command log views are provided in the following examples. These examples should not be construed as limiting. In addition, one or more command log views can be used separately or in combination when predicting a next command. Thus, according to various embodiments, the prediction engine 200 can receive data from a community data command stream (community data 210) and data from a specific user command stream (user specific data 220). The two command streams can be analyzed using one or more command log views applicable to one or both command streams, and the results used to predict the active user's next action,

### Command Log View Example 1

### Command Frequency

In some embodiments, for a command frequency-command log view, to determine an occurrence rate for use in predicting a next command, a command-to-command transition table can be created for an active user using the community data 210 and/or user specific data 220, where entry (i,j) contains the number of times command j immediately followed command i in a data set obtained from community data 210 and/or user specific data 220. The counts (i.e., the number of times command j immediately followed command i) in the table can be converted to probabilities (or occurrence rates).

In addition to a command-to-command transition table for the user specific data 220 (e.g., the command frequency-command log view of the user specific log), embodiments generate a command-to-command transition table for users in aggregate for community data 210 (e.g., the command frequency-command log view of the community log). The set of users in aggregate can be created from all available users' data or a subset of all the users. A transition table for an active user can be created from a data set of aggregate data from the user specific data 220 and the community data 210 as a whole or from a subset of the community data 210. According to this embodiment, command streams from one user and from all users are “viewed” (e.g., filtered or defined) based on command frequency and then combined.

In one embodiment, the counts from the community data 210 can be added to the counts from the active user's user specific data 220 before being converted to probabilities. This aggregate information provides a set of data around usage patterns among all or a subset of users of the particular productivity application.

The creation of the command-to-command transition table and the conversion of the numbers to probabilities (or occurrence rates) can be performed, in some embodiments, by the prediction engine 200. In some cases, an initial command-to-command transition table may be supplied to the prediction engine 200. The initial command-to-command transition table may then be updated and managed by the prediction engine 200, or updated tables may be provided to the prediction engine 200. Table 2 shows an example command-to-command transition table with occurrence rates of ordered command pairs. The rows represent an executed command and each column represents an occurrence rate for a given command to be the next command after the executed command. The table can be created for every available command. For example, where 2000 commands exist in a program, n=2000.

TABLE 2

| | C₁ | C₂ | C₃ | C₄ | C₅ | . . . | Cₙ |
|---|---|---|---|---|---|---|---|
| C₁ | .0002 | .0275 | .0005 | .0002 | .1582 | | .0009 |
| C₂ | .2007 | .0002 | .0002 | .6311 | .0005 | | .0002 |
| C₃ | .0478 | .0001 | .0005 | .5682 | .0223 | | .0004 |
| C₄ | .2343 | .0114 | .0004 | .1989 | .1853 | | .0884 |
| C₅ | .0003 | .0005 | .0007 | .0004 | .0005 | | .0006 |
| . . . | | | | | | | |
| Cₙ | .0674 | .0002 | .0018 | .4866 | .2100 | | .0060 |

Information found in a transition table such as shown in Table 2 can be used by the prediction engine 200 to predict a next action a user will take.

Some entries in the grid can be 0, indicating commands that are not used during the time the data set was captured. Lack of use of a command may be due to usage trends or program rules that prevent some commands from being available. In some embodiments, Laplace smoothing may be applied to deemphasize command pairs with very little information. In one embodiment, to generate a prediction, the row corresponding to the last executed command is searched for a highest probability next command. For example, referring to Table 2, if the last executed command was C₂, then C₄ is the highest probability next action based on the occurrence rate in that row.

### Command Log View Example 2

### User/Client Categorization

By knowing context of client type (e.g., type of computing device and/or application(s) running on device), certain predictive commands can be surfaced. For example, if it is determined that the user is working from a reader, then certain commands can be surfaced based on community and specific user information related to command usage on a reader device. Similar considerations can be made if it is determined that the user is working from a mobile device.

In some embodiments, user populations can be identified within the community data and those user populations used to create the specialized models where the active user falls within one of those user populations. For example, if someone uses a product, such as MICROSOFT WORD primarily to read and review documents instead of for significant creation and/or editing, that person can be considered to be part of a user population that uses the product for reading and reviewing documents. A specific model can be generated for this user population (based on user type) to predict their actions more accurately. The specialized models can be obtained from a command log view for a particular user type or population.

In addition to command log views provided based on how a user interacts with a particular productivity application, models can be viewed by population segment. To view by population segment, the aggregate data can be formed from people identified as having a particular knowledge or experience level. Data from the community of users may be grouped into subsets based on characteristics such as expertise (reflected, for example, by usage of particular commands), relationship to specific user, selection by the user, and the like. The subset selected for use in assisting the prediction of commands to surface can also be provided as a command log view.

For example, a group of users identified as good editors may have their data used to create the community model. For this case, all commands used by the users identified as good editors may be used to populate the community model. In another case, a group of users identified as being experienced at a particular area of a product (e.g., pivot tables) may be identified. Here, only the commands related to a particular area of a product are used to populate the community model. This type of selection takes into consideration that not everyone is an expert at all parts of a product, but some people may be very good at a few areas of a product. In some embodiments, models can be based on geographic region, for example the United States or Japan.

Command log views may also be based on social group. For example, commands can be predicted using command log views taking aggregate data obtained from a particular social group. For example, the aggregate data can be taken from a group of friends or co-workers of the user. In one embodiment, the aggregate data can be taken from a group of users of a company—or company-wide. For example, the aggregate data can be obtained from CompanyABC to provide usage patterns that can be used to help predict or guide other users working at CompanyABC.

### Command Log View Example 3

### Scenario

Command log views may be scenario based. For example, certain tasks may have preferred paths (i.e., a sequence of commands) or one or more paths intended to improve a user's experience or ease with a particular task. An example scenario involves document formatting. Often, text may be modified by changing font size, color, and style. However, it can be more efficient, in some cases, to apply a style to the document. A scenario based command log view can suggest applying a style to the document instead of manually modifying the text—even if the user does not usually use styles. For instance, a style gallery may be suggested as a predicted command to format a header rather than manually applying bold and increasing the font size.

The scenario-based command log view can be used for training users who want to learn a preferred path or a possibly more helpful path to perform a task than the one they already know or use.

In some products there can be scenarios in which multiple commands are often used where order may not be relevant. For example, in a scenario of formatting a chart, the actions of adding axis titles, changing colors and adding call-outs may happen in any order. User scenarios such as this can be identified and collected as a rule set. Thus, when a command that falls within a collection (as indicated by the rule) is received by the prediction engine, other commands in the collection can be surfaced as part of a predicted command set.

For example, a prediction engine can receive the active user's executed command and a scenario-related command rule set; analyze whether the active user's executed command falls within a collection described by the scenario-related command rule set; and include probable next command(s) from the collection in addition to those next command(s) predicted from a command-to-command transition table of aggregate user data.

In one embodiment, the scenario-related command rule set may be used when generating a command-to-command transition table to weight certain next commands, for example by including a next command for one of the commands in the collection included in the count of number of times that next command followed each of the other commands in the collection.

### Command Log View Example 4

### Location

By knowing context of client location, predictive commands directed to tasks generally performed at that location may be surfaced. For example, when a user indicates that they are working from their office, certain commands may be more likely to be used as opposed to when a user is working within the same application from home. According to an embodiment, a command log view can be obtained for a particular location or locations (e.g., “commands issued while at work”)

### Command Log View Example 5

### Time of Day

By knowing context of when (date/time) certain commands are executed, the predicted commands may be viewed based on time-related preferences. For example, commands performed during the day from Monday to Friday may relate to work.

### Command Log View Example 6

### Temporal Information

In certain embodiments, a command log view can be obtained from the user specific data and/or the community data based on temporal information. Temporal information includes, but is not limited to, order of commands, date and time a command is executed, and time between certain commands (which may be but are not necessarily consecutive commands).

In some embodiments, a command log view can be obtained based on how close commands are to each other in time. For example, commands used very close to each other in time, for example within a period of five minutes or during a certain session, can be grouped together and used in predicting a next command.

In some embodiments, a command log view can be obtained based on how long it has been since a user has executed a command. For example, an extended period of time since a last command was executed may indicate that a user is searching for a desired next command, a new command, a command not often used, or a command that is difficult to find (because located deep in a menu). An action a user takes after a long pause may be helpful in predicting the next command. In addition, data about a command that was previously used but has not been recently used (within a certain amount of time such as a week, a month, multiple months or even a year or more) may be used in predicting the next command.

According to various embodiments, different command log views can be selected by the prediction engine and then used to predict a next command.

When the community information is combined with an active user's data, the aggregate information can act as a prior probability.

A prior probability refers to a probability that takes into account previous data to form an initial assumption. Areas of the product where a user has no history can (at least initially) be based on the community's patterns. As the active user begins to use these features the active user's usage patterns can override the community's usage patterns. In one embodiment, the active user's usage patterns can be given a higher weight than the community data to provide greater customization of the predictions. In another embodiment, the community information merely provides an initial value for the probabilities, which become replaced (or adjusted) with user specific data as more data points are obtained for a particular user.

For example, if the aggregate information indicates strong data for cut following paste from all users, but a particular user always performed a comment operation after pasting, that user's data would override the aggregate data.

As more data becomes available for an individual, predicting a next command can become more accurate.

The usage data may be collected over a period of time. In some cases, as time goes on, oldest data can be discarded and newer data can be incorporated to update the usage data. In some cases, historical patterns can be monitored and data from only designated time periods used. For example, usage data from summer time may be discarded and data from a school semester time period be used. The counts in the table may be batch updated or continuously updated.

In a further embodiment, which is applicable to each of the command log views, a prediction confidence threshold is included. By using the confidence threshold, any column containing a probability over a certain threshold may be used to generate a set of predictions for a next command. If the predictions are below the certain confidence threshold, the system may not make a prediction. For example, given a confidence threshold of 50%, the system may only surface predictions when it is at least 50% confident a command will be chosen next.

By adding a prediction threshold, the accuracy increases but the prediction rate decreases. For example, with an 80% confidence threshold, the prediction accuracy for a prototype system using specific user data was found to be 84%, but the system did not make a prediction 43% of the time.

Generally, there will be more than one command that each command may follow. Therefore, a 100% probability that one command will always follow another command may not occur. However, a set of most likely next commands can be provided. In some embodiments, the set can contain 2-5 most likely next commands. For example, 1, 2, or 3 commands may be provided, 2 commands may always be provided, 3 commands may always be provided, 3-5 commands may be provided, more than 5 commands may be provided, or up to 10 commands may be provided in various embodiments.

In some cases, the highest probability next command along with any other commands in the order from highest probability to lower probability commands are included in a set of predictions for a next command until the combined probability reaches or exceeds a certain threshold. Here, the commands can be displayed when the sum of their confidence values exceeds the confidence threshold. For example, in the case of surfacing three commands and using a 60% probability threshold, the three commands will be surfaced when the confidence values of the three commands combine to a greater than 60% accuracy. This approach is one way to generate predictions when a single command does not meet a particular confidence threshold.

FIGS. 3A and 3B show example scenarios that may be implemented by embodiments of the invention.

In one embodiment a most recent command that the user invokes is used when predicting the next action. That is, the prediction engine receives the most recently executed command as an input. In another embodiment, the two most recent commands that the user invoked are used when predicting the next action. In yet another embodiment, three or more commands are used. According to various embodiments, 1, 2, 3, 4, 5, 6, 7, 8, or all commands in a user's history are used to predict the next action. The most recently executed commands may be (briefly) stored in a cache memory location while an active user is using a productivity application, and this information provided to the prediction engine.

Referring to FIG. 3A, a prediction engine 300 can receive the active user's last certain number (n) of executed commands 302 and use the commands to select one or more probable commands to output as predicted commands 304. The active user's executed commands may be used to look-up highest valued next commands in a command-to-command transition table 306. The table 306 can be created based on one or more command log views of the specific user data and/or the community data. In some embodiments, the table 306 can be created by the prediction engine from the various data sources (specific user data and community data). In some other embodiments, the table 306 can be provided to the prediction engine, for example, by another computing device or cloud service.

In some cases, information related to context can also be obtained through analysis of an active user's last certain number of commands. In some cases, context information corresponding to the user's last certain number of commands can be obtained from the user specific data (which may include session data from previous sessions). The certain number of commands from the user specific data can be, for example, 1, 2, 3, 4, less than 5, 5, between 1 and 10, or greater than 10.

The prediction engine 300 can receive the active user's last certain number (n) of commands; analyze the commands (for example through pattern recognition); and use the analysis to select probable next command(s) 304 from the command-to-command transition table 306.

Using the analysis of the commands to select probable next commands may include applying weight to certain values in the table or using the analysis to narrow down which commands will be surfaced to the user. In some cases, the analysis of the commands can affect the selection of community data aggregated as part of the table. For example, the context determined from the user commands 302 can be used to select a particular community log view of the community data.

For example, multiple commands related to creating and modifying a table of content can indicate a context of arranging relationships between content in a table, and predicted commands may be provided based on modifying or illustrating tabular data (and even making graphs or plots for visual representation of the content).

Context information may also be determined through an analysis of the commands executed during a user's session as a whole (as opposed to only recent commands or consecutive commands). For example, a large number of paste commands may indicate that the user is working within multiple documents or applications to insert content. Such context may support a predictive command for inserting content from a file or a hyperlink.

Referring to FIG. 3B, in some embodiments, the application state 320 is an input to the prediction engine 322. The application state 320 can be used by the prediction engine 322 to determine whether a probable next command is currently executable. In some embodiments, the determination can be carried out by accessing a rule set for available commands. For example, a product may have a rule that the “Crop Picture” command is not available to be used when text (not a picture or image) is selected. Thus, a next predicted command (e.g., 324) would not include those commands indicated as being invalid actions by a rule set. The invalid commands can be removed from the grouping of commands searched by the prediction engine for highest probabilities before or after selecting commands with highest probabilities. That is, invalid actions can be discarded from the set of predictions before the predictions are surfaced to the user.

It should be understood that the above examples described with respect to FIGS. 3A and 3B are merely illustrative of some example scenarios and are not intended to illustrate all available scenarios.

In certain embodiments, the predicted commands can include at least one recommended command related to a feature that the user may not be aware would be helpful as a next command. The recommended command may be a new command that the user has not before executed.

To determine commands that are previously unused by a particular user, a weighting function may be utilized, such as described by J. Matejka, W. Li, T. Grossman and G. Fitzmaurice, “CommunityCommands: Command Recommendations for Software Applications,” (UIST 2009 Conference Proceedings: ACM Symposium on User Interface Software & Technology, 2009). It should be understood that this is just one example of a weighting function that may be used to provide additional recommended commands not before executed by the active user and that other approaches may be used.

The weighting function described by Metejka et al. is referred to as “command frequency, inverse user frequency” (cf-iufᵢⱼ), which gives preference to highly frequent commands that are used by small portions of the overall population of users, and is defined as:

$$cf \text{-} {iuf}_{ij} = \frac{\vert command i executions by user j \vert}{\vert all command executions by user j \vert} * log \frac{\vert all users \vert}{\vert users that use command i \vert} .$$

This weighting function takes the number of executions of each command i by user j over the total number of commands executed by the user j in a data set, and multiplies this ratio with the percentage of total users that use the command i.

In various embodiments, the users in the set of “all users” can be a subset of users specifically selected as being part of a population segment. For example, the set of users may be those identified as having a particular knowledge or experience level, geographical location, being associated with a particular social or work group, or identified as some other segment.

According to an embodiment, as a preprocessing step, a vector is generated for every command in the product being used to edit or create content. These vectors include an entry for each user and contain the corresponding cf-iufᵢⱼ value. From these vectors, a command-to-command similarity matrix is built by measuring the distance between the vectors. In one embodiment, the distance between vectors can be determined by calculating the cosine of the angle θ between the command vectors Vₐ, V_{b} for each pair of commands a and b. For example, the matrix can be populated by calculating

$$cos ( {θ}_{{V}_{a} , {V}_{b}} ) = \frac{{V}_{a} \cdot {V}_{b}}{‖ {V}_{a} ‖ * ‖ {V}_{b} ‖}$$

for each pair of commands.

According to an embodiment, when a user uses a productivity application, the system on which the application is running can track all the commands he/she executes and generate recommendations by selecting the undiscovered (or unused) commands with highest similarity. A value of 1 indicates most similar and a value of 0 indicates no similarity. To generate the recommendation, a search of the command-to-command similarity matrix is performed to find commands that are not in the set of commands used by the user in a current session (or in the history of the user). A certain number of those undiscovered/unused commands having the highest score from within the group of undiscovered/unused commands are selected. One or more of these selected undiscovered/unused commands can be surfaced to the user.

According to certain embodiments, the recommended commands may be interspersed with predicted commands. In other embodiments, recommended commands are presented separate from predicted commands. In one or both cases, commands may have a visual or audible designation for differentiation between commands that are recommended (such as based on commands not before used by the user) and commands that are predicted (based on commands that the system predicts the user will next use). In yet other embodiments, the functions applied to provide recommended commands can be used to weight the predicted commands such that the predicted commands are narrowed to a subset based on, for example, a population set.

FIG. 4 shows a process flow diagram of a method for surfacing commands within a user interface of a productivity application according to an embodiment of the invention. According to certain embodiments, a method for surfacing commands within a user interface of a productivity application can include receiving user specific data for an active user of a productivity application and community data (410). The community data and the user specific data can be command usage history data for a same or different version of the productivity application (and in some cases even for a different productivity application, but one with similar or relevant commands). In operation 420, prediction calculations are performed using one or more command log views of the user specific data and the community data to select predicted commands. Once the predicted commands are selected, the predicted commands are displayed to the active user (430). The prediction calculations and command log views can be any one of the methods and views described above.

For example, in some embodiments, performing the prediction calculations using one or more command log views of the user specific data and the community data includes using command frequency from the user specific data and the community data to determine probable commands.

In one embodiment, the prediction calculations can be performed by generating a command-to-command transition table using the community data and the user specific data; determining probable commands that have an occurrence rate above a threshold by searching the command-to-command transition table for an executed command's next command having the occurrence rate above the threshold and assigning the next command having the occurrence rate above the threshold as one of the probable commands; and selecting at least one of the probable commands for the predicted commands.

In another embodiment, the prediction calculations can be performed by generating a command-to-command transition table using the community data and the user specific data; determining probable commands that have an occurrence rate above a threshold by searching the command-to-command transition table for an executed command's one or more next commands having highest occurrence rates and assigning the one or more next commands for an executed command as one of the probable commands beginning from highest occurrence rate to lowest occurrence rate until a combined occurrence rate exceeds the threshold; and selecting at least one of the probable commands for the predicted commands.

In any embodiment, the prediction calculations can also include searching community data for a next command from a set of commands not found in the user specific data, wherein at least one predicted command is from the set of commands not found in the user specific command usage history.

In any of the embodiments described above, context data received for an active user session of the productivity application can be used during performing prediction calculations. The context information can include at least one of command timestamp, user location, content, and application state.

According to various embodiments, performing the prediction calculations using one or more command log views of the user specific data and the community data can include using at least one command log view of the user specific data and the community data selected from the group consisting of command frequency command log view, client type command log view, population segment command log view, and temporal command log view.

It should be understood that the methods of performing the prediction calculations are not limited to those described above. Other methods may be used in addition to or in place of the methods described above. The other methods that can be used by the prediction engine when acting on user specific and community data include, but are not limited to, hierarchical and non-hierarchical Bayesian methods; supervised learning methods such as Support vector Machines, neural nets, bagged/boosted or randomized decision trees, and k-nearest neighbor; and unsupervised methods such as k-means clustering and agglomerative clustering. In some cases, other methods for clustering data in combination with computed auxiliary features may be used by the prediction engine as appropriate.

In some embodiments, the methods described above can be carried out by a processor executing computer-readable instructions that are stored on a computer readable storage medium. In one specific embodiment, the instructions can include instructions for generating a command-to-command transition table using community command usage history for a productivity application and user specific command usage history; determining at least one predicted command using the command-to-command transition table and context information for an active user session of the productivity application; and displaying the at least one predicted command. Occurrence rates of commands in the command-to-command transition table can be weighted to favor next commands from the user specific command usage history over next commands from the community information. The context information can include at least one of command timestamp, user location, content, and application state.

The instructions can also include instructions for selecting command information from a segment of a general user population, wherein the command-to-command transition table is generated using community information only from the segment of the general user population.

In some cases, the instructions for determining the at least one predicted command using the command-to-command transition table and context information for an active user session of the productivity application can include instructions for determining probable commands that have an occurrence rate above a threshold by searching the command-to-command transition table for an executed command's next command having the occurrence rate above the threshold; assigning the next command having the occurrence rate above the threshold as one of the probable commands; and selecting at least one of the probable commands as the at least one predicted command.

In some cases, the instructions for determining the at least one predicted command using the command-to-command transition table and context information for an active user session of the productivity application can include instructions for determining probable commands that have an occurrence rate above a threshold by searching the command-to-command transition table for an executed command's one or more next commands having highest occurrence rates; and assigning the one or more next commands for an executed command as one of the probable commands beginning from highest occurrence rate to lowest occurrence rate until a combined occurrence rate exceeds the threshold; and selecting at least one of the probable commands as the at least one predicted command.

In any of the above cases, the instructions can include instructions for searching the community information for a next command from a set of commands not found in the user specific command usage history, wherein at least one predicted command is from the set of commands not found in the user specific command usage history.

In certain embodiments, a system for surfacing commands within a user interface of a productivity application can be provided that includes a prediction engine configured to generate a personalized community model and select probable next commands according to the personalized community model for displaying in a user interface; a command log for storing user specific command usage history; and a community log for storing community information from a population of users of a productivity application.

The personalized community model can employ specific user data from the command log, community data from the community log, and context information. The context information can include at least one of command timestamp, user location, content, and application state.

In some embodiments, the prediction engine is configured to generate the personalized community model by generating a command-to-command transition table using the community information from at least a segment of the population of users and user specific command usage history. The prediction engine can also be configured to select the probable next commands by determining next commands in the command-to-command transition table that alone or in combination have an occurrence rate above a threshold.

FIG. 5 shows a user interface in which predicted commands are surfaced according to an embodiment of the invention. Referring to FIG. 5, a user may interact with a computing device such as tablet 500. When a user selects text 510 on a canvas 520 displayed on tablet 500, a toolbar 530 can appear that includes surfaced commands 540. Three commands are shown in FIG. 5; however, embodiments are not limited to the surfacing of three commands. For example, in some embodiments, 1, 2, 3, 4, 5, 6, 7, or a varying number from 1-7 commands, such as 1-3, 2-5, 2-3, 1-4, 1-5, or 2-4, may be surfaced.

In the example, a user may have executed the command to cause the selected text 510 to become “bold”. The toolbar 530 can then surface predicted commands 540 according to the output of a prediction engine (such as described with respect to FIG. 2). For example, underline, cut, and copy may indicate as having a highest probability of being a next command after a user uses a bold command and, therefore, are surfaced for the user. The surfaced commands can be based on the active user's usage patterns and previous command. In some embodiments, the predicted commands 540 may include commands based on a variety of command log views.

FIG. 6 shows an example process by which predicted commands are surfaced in a user interface according to an embodiment of the invention. Referring to FIG. 6, while an application is running, context can be determined (602). As previously mentioned, context includes, but is not limited to, content, history, location, application type, application state, file, and the like, which create the user's environment and which indicates what types of tools or commands may be available for interacting with the environment. The determination of context (602) can be performed while a user interacts with a canvas (such as canvas 520 of FIG. 5) presented by an application.

In one embodiment, a prediction engine can receive the information related to context and select probable commands (604) from a command-to-command transition table and/or a command-to-command similarity matrix based on the context. The command-to-command transition table may be generated from only the user's history; the user's history combined with aggregate user data; the combination of the user's history and aggregate user data weighted to the active user; or the combination of the user's history and aggregate user data weighted to aggregate user data similar commands. The aggregate user data may be based on various population segments. The command-to-command similarity matrix may be based on various population segments.

Moving on to operation 606, the system determines if condition(s) for surfacing a predictive command are met. The conditions for surfacing a predictive command can be based on certain actions (or inactions) by a user, which indicate that an editing command may be desired.

The user's actions (or inactions) that may indicate that an editing command may be desired (and that can be conditions predicating the surfacing of a predictive command) include, but are not limited to, a manipulation to open a toolbar or menu, inactivity for a period of time, a series of interactions with a toolbar or menu that do not result in a selection of a command (e.g., when multiple tabs of a Ribbon-style toolbar are selected without executing a command), a selection of content, a right click from a mouse, a gesture (e.g., a touch, tapping, swipe, or the like), or voice input. The selection of content may be accomplished by interactions including, but not limited to, a mouse click, touch or tapping of a touch pad (or touch screen), hold and drag (via an input device), gestural selection, or other suitable user input mechanism.

The user's actions (or inactions) may also be used by the prediction engine to select probable commands. This input may be considered part of the context.

If the application determines, at operation 606, that the conditions have been met for surfacing a predictive command, the method proceeds to operation 608, wherein predicted commands can be surfaced in a UI.

The dynamic (i.e. changing based on context/executed command) surfacing of commands can be presented for a user on an individual basis instead of simply delivering experiences for a generalized user (e.g., based on the experience of most users or an “average” user). Embodiments can perform better than simply surfacing the 3-5 most commonly used commands. In particular, based on the test data for MICROSOFT WORD, the top 5 commands make up about 30% of the total command invocations. This is about 50% below the accuracy obtained using the test data with the various approaches tested. It can be common in a number of products that the top 10 commands make up 50% (or even more) of all commands issued. However, even with surfacing more commands, current research indicates that additional considerations would be useful in predicting an appropriate command for a user.

In some embodiments, user data is increased by collecting data from the same user across devices (such as across devices 110, 118-1, and 118-2 shown in FIG. 1). The across-device collection can be carried out, for example, where a user signs in to use a program or accesses the program from a client device communicating with a server running the productivity application. In some embodiments where a user uses a same product or program on multiple devices, commands performed within one session on one computing device may be combined with commands performed within a session on another computing device in order to capture additional command usage data from the user.

In addition, where a user accesses a productivity application across multiple platforms according to a unique identity (a particular identifier for the user), the data about the user's command usage can roam with the user.

The amount of training data can impact the accuracy of the aggregate prediction model. Based on the data used in testing a prototype, which included data collected (with permission) from a year time period for more than 30 thousand consumers across 1.3 million sessions with a total of over 180 million commands executions, stable accuracy was accomplished using less than 50,000 training sessions. Embodiments can include aggregate data tables that take into consideration the amount of training sessions to establish a stable accuracy.

An illustrative architecture for the user computing device 110 is provided with reference to FIGS. 7 and 8.

Referring to FIG. 7, the architecture for the user computing device 110 can include a device operating system (OS) 710. The device OS 710 manages user input functions, output functions, storage access functions, network communication functions, and other functions for the device. The device OS 710 may be directly associated with the physical resources of the device or running as part of a virtual machine backed by underlying physical resources. According to many implementations, the device OS 710 includes functionality for recognizing user gestures and other user input via the underlying hardware 715.

An interpretation engine 720 of an application 730 running on the device OS 710 listens (e.g., via interrupt, polling, and the like) for user input event messages from the device OS 710. The UI event messages can indicate a panning gesture, flicking gesture, dragging gesture, or other gesture on a touchscreen of the device, a tap on the touch screen, keystroke input, or other user input (e.g., voice commands, directional buttons, trackball input). The interpretation engine 720 translates the UI event messages into messages understandable by the application.

FIG. 8 shows a block diagram illustrating components of a computing device used in some embodiments. For example, system 800 can be used in implementing a user or client computing device in the form of a desktop or notebook computer or a tablet or a smart phone or the like that can run one or more applications. In some embodiments, system 800 is an integrated computing device, such as an integrated PDA and wireless phone. It should be understood that aspects of the system described herein are applicable to both mobile and traditional desktop computers, as well as server computers and other computer systems. For example, touchscreen or touch-enabled devices (included, but not limited to, touch-enabled track pad or mouse) may be applicable to both mobile and desktop devices.

System 800 includes a processor 805 that processes data according to instructions of one or more application programs 810, and/or operating system 820. The processor 805 may be, or is included in, a system-on-chip (SoC) along with one or more other components such as sensors (e.g., magnetometer, an ambient light sensor, a proximity sensor, an accelerometer, a gyroscope, a Global Positioning System sensor, temperature sensor, shock sensor) and network connectivity components (e.g., including Radio/network interface 835).

The one or more application programs 810 may be loaded into memory 815 and run on or in association with the operating system 820. Examples of application programs include phone dialer programs, e-mail programs, PIM programs, word processing programs, spreadsheet programs, other productivity applications, Internet browser programs, messaging programs, game programs, and the like. Other applications may be loaded into memory 815 and run on the device, including various client and server applications.

It can be understood that the memory 815 may involve one or more memory components including integrated and removable memory components and that one or more of the memory components can store an operating system. According to various embodiments, the operating system includes, but is not limited to, SYMBIAN OS from Symbian Ltd., WINDOWS MOBILE OS from Microsoft Corporation, WINDOWS PHONE OS from Microsoft Corporation, WINDOWS from Microsoft Corporation, PALM WEBOS from Hewlett-Packard Company, BLACKBERRY OS from Research In Motion Limited, IOS from Apple Inc., and ANDROID OS from Google Inc. Other operating systems are contemplated.

System 800 also includes non-volatile storage 825 within memory 815. Non-volatile storage 825 may be used to store persistent information that should not be lost if system 800 is powered down. Application programs 810 may use and store information in non-volatile storage 825, such as a record of commands executed during the creation or modification of content in a productivity application and the like. A synchronization application may also be included and reside as part of the application programs 810 for interacting with a corresponding synchronization application on a host computer system (such as a server) to keep the information stored in non-volatile storage 825 synchronized with corresponding information stored at the host computer system.

System 800 has a power supply 830, which may be implemented as one or more batteries and/or an energy harvester (ambient-radiation, photovoltaic, piezoelectric, thermoelectric, electrostatic, and the like). Power supply 830 may further include an external power source, such as an AC adapter or a powered docking cradle that supplements or recharges the batteries.

System 800 may also include a radio/network interface 835 that performs the function of transmitting and receiving radio frequency communications. The radio/network interface 835 facilitates wireless connectivity between system 800 and the “outside world,” via a communications carrier or service provider. Transmissions to and from the radio/network interface 835 are conducted under control of the operating system 820, which disseminates communications received by the radio/network interface 835 to application programs 810 and vice versa.

The radio/network interface 835 allows system 800 to communicate with other computing devices, including server computing devices and other client devices, over a network.

An audio interface 840 can be used to provide audible signals to and receive audible signals from the user. For example, the audio interface 840 can be coupled to speaker to provide audible output and a microphone to receive audible input, such as to facilitate a telephone conversation or receive voice commands. System 800 may further include video interface 845 that enables an operation of an optional camera (not shown) to record still images, video stream, and the like.

Visual output can be provided via a touch screen display 855. In some cases, the display may not be touch screen and user input elements, such as buttons, keys, roller wheel, and the like are used to select items displayed as part of a graphical user interface on the display 855. A keypad 860 can also be included for user input. The keypad 860 may be a physical keypad or a soft keypad generated on the touch screen display 855. In some embodiments, the display and the keypad are combined. In some embodiments two or more input/output (I/O) components including the audio interface 840 and video interface 845 may be combined. Discrete processors may be included with the I/O components or processing functionality may be built-in to the processor 805.

The display 855 may present graphical user interface (“GUI”) elements, a predictive contextual toolbar user interface (or other identifiable region on which predictive commands may be surfaced), text, images, video, notifications, virtual buttons, virtual keyboards, messaging data, Internet content, device status, time, date, calendar data, preferences, map information, location information, and any other information that is capable of being presented in a visual form. In some embodiments, the display 855 is a liquid crystal display (“LCD”) utilizing any active or passive matrix technology and any backlighting technology (if used). In some embodiments, the display 855 is an organic light emitting diode (“OLED”) display. Of course, other display types are contemplated.

A touchscreen (which may be associated with the display) is an input device configured to detect the presence and location of a touch. The touchscreen may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some embodiments, the touchscreen is incorporated on top of a display as a transparent layer to enable a user to use one or more touches to interact with objects or other information presented on the display.

In other embodiments, a touch pad may be incorporated on a surface of the computing device that does not include the display. For example, the computing device may have a touchscreen incorporated on top of the display and a touch pad on a surface opposite the display.

In some embodiments, the touchscreen is a single-touch touchscreen. In other embodiments, the touchscreen is a multi-touch touchscreen. In some embodiments, the touchscreen is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures may be implemented in software for use with the touchscreen. As such, a developer may create gestures that are specific to a particular application program.

In some embodiments, the touchscreen supports a tap gesture in which a user taps the touchscreen once on an item presented on the display. The tap gesture may be used for various reasons including, but not limited to, opening or launching whatever the user taps. In some embodiments, the touchscreen supports a double tap gesture in which a user taps the touchscreen twice on an item presented on the display. The double tap gesture may be used for various reasons including, but not limited to, zooming in or zooming out in stages, and selecting a word of text. In some embodiments, the touchscreen supports a tap and hold gesture in which a user taps the touchscreen and maintains contact for at least a pre-defined time. The tap and hold gesture may be used for various reasons including, but not limited to, opening a context-specific menu.

In some embodiments, the touchscreen supports a pan gesture in which a user places a finger on the touchscreen and maintains contact with the touchscreen while moving the finger on the touchscreen. The pan gesture may be used for various reasons including, but not limited to, moving through screens, images, or menus at a controlled rate. Multiple finger pan gestures are also contemplated. In some embodiments, the touchscreen supports a flick gesture in which a user swipes a finger in the direction the user wants the screen to move. The flick gesture may be used for various reasons including, but not limited to, scrolling horizontally or vertically through menus or pages. In some embodiments, the touchscreen supports a pinch and stretch gesture in which a user makes a pinching motion with two fingers (e.g., thumb and forefinger) on the touchscreen or moves the two fingers apart. The pinch and stretch gesture may be used for various reasons including, but not limited to, zooming gradually in or out of a website, map, or picture.

Although the above gestures have been described with reference to the use of one or more fingers for performing the gestures, other appendages such as toes, a nose, chin, or objects such as styluses may be used to interact with the touchscreen. As such, the above gestures should be understood as being illustrative and should not be construed as being limiting in any way.

It should be understood that any mobile or desktop computing device implementing system 800 may have more or fewer features or functionality than described and is not limited to the configurations described herein.

In various implementations, data/information stored via the system 800 may include data caches stored locally on the device or the data may be stored on any number of storage media that may be accessed by the device via the radio/network interface 835 or via a wired connection between the device and a separate computing device associated with the device, for example, a server computer in a distributed computing network, such as the Internet. As should be appreciated such data/information may be accessed through the device via the radio interface 835 or a distributed computing network. Similarly, such data/information may be readily transferred between computing devices for storage and use according to well-known data/information transfer and storage means, including electronic mail and collaborative data/information sharing systems.

Certain techniques set forth herein may be described in the general context of computer-executable instructions, such as program modules, executed by one or more computing devices. Generally, program modules include routines, programs, objects, components, and data structures that perform particular tasks or implement particular abstract data types.

Embodiments may be implemented as a computer process, a computing system, or as an article of manufacture, such as a computer program product or computer-readable medium. Certain methods and processes described herein can be embodied as code and/or data, which may be stored on one or more computer-readable media. Certain embodiments of the invention contemplate the use of a machine in the form of a computer system within which a set of instructions, when executed, can cause the system to perform any one or more of the methodologies discussed above. Certain computer program products may be one or more computer-readable storage media readable by a computer system and encoding a computer program of instructions for executing a computer process.

Computer-readable media can be any available computer-readable storage media or communication media that can be accessed by the computer system.

Communication media include the mechanisms by which a communication signal containing, for example, computer-readable instructions, data structures, program modules, or other data, is transmitted from one system to another system. The communication media can include guided transmission media, such as cables and wires (e.g., fiber optic, coaxial, and the like), and wireless (unguided transmission) media, such as acoustic, electromagnetic, RF, microwave and infrared, that can propagate energy waves. Computer-readable instructions, data structures, program modules, or other data can be embodied as a modulated data signal in, for example, a wireless medium such as a carrier wave or similar mechanism such as employed as part of a spread spectrum technique. The term “modulated data signal” refers to a signal that has one or more of its characteristics changed or set in a manner as to encode information in the signal. The modulation may be analog, digital or a mixed modulation technique. Communication media, particularly carrier waves and other propagating signals that may contain data usable by a computer system, are not included as computer-readable storage media.

By way of example, and not limitation, computer-readable storage media may include volatile and non-volatile, removable and non-removable media implemented in any method or technology for storage of information such as computer-readable instructions, data structures, program modules or other data. For example, a computer-readable storage medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); or other media now known or later developed that is capable of storing computer-readable information/data for use by a computer system. “Computer-readable storage media” do not consist of carrier waves or propagating signals

In addition, the methods and processes described herein can be implemented in hardware modules. For example, the hardware modules can include, but are not limited to, application-specific integrated circuit (ASIC) chips, field programmable gate arrays (FPGAs), and other programmable logic devices now known or later developed. When the hardware modules are activated, the hardware modules perform the methods and processes included within the hardware modules.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

It should be understood that the examples and embodiments described herein are for illustrative purposes only and that various modifications or changes in light thereof will be suggested to persons skilled in the art and are to be included within the spirit and purview of this application.

What is claimed is:

1. A method for surfacing commands within a user interface of a productivity application, comprising:
receiving user specific data for an active user of a productivity application;
receiving community data;
performing prediction calculations using one or more command log views of the user specific data and the community data to select predicted commands; and
displaying predicted commands.

2. The method of claim 1, wherein performing the prediction calculations using one or more command log views of the user specific data and the community data comprises:
using command frequency from the user specific data and the community data to determine probable commands.

3. The method of claim 2, wherein performing the prediction calculations comprises:
generating a command-to-command transition table using the community data and the user specific data;
determining probable commands that have an occurrence rate above a threshold by:
searching the command-to-command transition table for an executed command's next command having the occurrence rate above the threshold; and
assigning the next command having the occurrence rate above the threshold as one of the probable commands; and
selecting at least one of the probable commands for the predicted commands.

4. The method of claim 2, wherein performing the prediction calculations comprises:
generating a command-to-command transition table using the community data and the user specific data;
determining probable commands that have an occurrence rate above a threshold by:
searching the command-to-command transition table for an executed command's one or more next commands having highest occurrence rates; and
assigning the one or more next commands for an executed command as one of the probable commands beginning from highest occurrence rate to lowest occurrence rate until a combined occurrence rate exceeds the threshold; and
selecting at least one of the probably commands for the predicted commands.

5. The method of claim 1, wherein performing the prediction calculations comprises searching community data for a next command from a set of commands not found in the user specific data, wherein at least one predicted command is from the set of commands not found in the user specific command usage history.

6. The method of claim 1, further comprising receiving context data for an active user session of the productivity application, wherein the context data is used during performing prediction calculations.

7. The method of claim 6, wherein the context information comprises at least one of command timestamp, user location, content, and application state.

8. The method of claim 6, wherein performing the prediction calculations using one or more command log views of the user specific data and the community data comprises:
using at least one command log view of the user specific data and the community data selected from the group consisting of command frequency command log view, client type command log view, population segment command log view, and temporal command log view.

9. A computer readable storage medium having instructions stored thereon that, when executed by a processor, perform a method comprising:
generating a command-to-command transition table using community command usage history for a productivity application and user specific command usage history;
determining at least one predicted command using the command-to-command transition table and context information for an active user session of the productivity application; and
displaying the at least one predicted command.

10. The medium of claim 9, wherein occurrence rates of commands in the command-to-command transition table are weighted to favor next commands from the user specific command usage history over next commands from the community information.

11. The medium of claim 9, wherein the method further comprises selecting command information from a segment of a general user population, wherein the command-to-command transition table is generated using community information only from the segment of the general user population.

12. The medium of claim 9, wherein determining the at least one predicted command comprises:
determining probable commands that have an occurrence rate above a threshold by:
searching the command-to-command transition table for an executed command's next command having the occurrence rate above the threshold;
assigning the next command having the occurrence rate above the threshold as one of the probable commands; and
selecting at least one of the probable commands as the at least one predicted command.

13. The medium of claim 9, wherein determining the at least one predicted command comprises:
determining probable commands that have an occurrence rate above a threshold by:
searching the command-to-command transition table for an executed command's one or more next commands having highest occurrence rates; and
assigning the one or more next commands for an executed command as one of the probable commands beginning from highest occurrence rate to lowest occurrence rate until a combined occurrence rate exceeds the threshold; and
selecting at least one of the probable commands as the at least one predicted command.

14. The medium of claim 9, wherein the method further comprises:
searching the community information for a next command from a set of commands not found in the user specific command usage history, wherein at least one predicted command is from the set of commands not found in the user specific command usage history.

15. The medium of claim 9, wherein the context information comprises at least one of command timestamp, user location, content, and application state.

16. A system for surfacing commands within a user interface of a productivity application, comprising:
a prediction engine configured to generate a personalized community model and select probable next commands according to the personalized community model for displaying in a user interface;
a command log for storing user specific command usage history; and
a community log for storing community information from a population of users of a productivity application.

17. The system of claim 16, wherein the personalized community model employs specific user data from the command log, community data from the community log, and context information.

18. The system of claim 17, wherein the context information comprises at least one of command timestamp, user location, content, and application state.

19. The system of claim 16, wherein the prediction engine is configured to generate the personalized community model by generating a command-to-command transition table using the community information from at least a segment of the population of users and user specific command usage history.

20. The system of claim 19, wherein the prediction engine is configured to select the probable next commands by determining next commands in the command-to-command transition table that alone or in combination have an occurrence rate above a threshold.
